(19) United States
(12) Patent Application Publication
(10) Pub. No.: US 2004/0131818 A1
(43) Pub. Date: Jul. 8, 2004

(54) Self-posting sign

(75) Inventor: Maria D. McKillip, Rockford, IL (US)

Correspondence Address: FITCH EVEN TABIN AND FLANNERY, 120 SOUTH LA SALLE STREET, SUITE 1600, CHICAGO, IL, 60603-3406, US

(73) Assignee: MALESSA PARTNERS, L.L.C.

(21) Appl. No.: 10/743,504

(22) Filed: Dec. 22, 2003

Related U.S. Application Data
(63) Continuation of application No. 10/215,123, filed on Aug. 8, 2002, now abandoned.
(60) Provisional application No. 60/310,930, filed on Aug. 8, 2001.

(51) Int. Cl. G09F 7/00; B41M 1/26; B32B 7/12; B32B 31/12; B32B 31/18

(52) U.S. Cl. 428/41.8; 156/277; 156/289; 156/257; 156/268; 428/42.1

(57) ABSTRACT

A sign for posting on the interior or exterior of a transparent or opaque surface without the use of any secondary adhesive material, such as any variety of tape, Velcro, suction cup or any other secondary adhesive device, apparatus or method. The sign can be printed on either or both sides using a desktop printer or other printing device. If printed on both sides and affixed to a transparent surface such as glass, a single sign then yields two signs. The sign can be cut into a variety of shapes using virtually any type of paper stock or adhesive.

### CROSS-REFERENCE TO RELATED APPLICATION

This application claims the benefit of U.S. Provisional Application No. 60/310,930, filed Aug. 8, 2001.

### FIELD OF THE INVENTION

This invention relates generally to signs and methods of adhering signs to surfaces and, more particularly, to self-posting signs and methods of making and applying self-posting signs.

### BACKGROUND OF THE INVENTION

It is common for substrate sheet material, such as paper, to be printed on using a computer and desktop printer or other printing device. This material is than posted as a sign using a secondary material, such as adhesive tape, Velcro, etc. The secondary material used for posting is applied after the printing step because printing devices cannot accommodate the adhesive surface, or other type surface. One existing alternative is to print on a pressure sensitive sheet. However, known shortcomings with this alternative include that the sheet can only be printed on one side and that it would have to be posted on the exterior of the surface. Thus, if the surface is outdoors, it leaves the sign exposed to the elements, such as rain, wind, etc., and most likely will be damaged to the point where it is unreadable.

### SUMMARY OF THE INVENTION

In accordance with the present invention there is provided a sign that includes a first substrate layer having a printable side and an opposite side. The sign also includes an adhesive layer attached to the opposite of the first substrate layer and a second substrate layer having an adhesive releasable side attached to the adhesive layer and an opposite printable side. At least a portion of the second layer is removable to expose the adhesive layer. Indicia is printed on at least one of the printable sides of the first and second substrate layers.

The first substrate layer may be of printable stock of virtually any type, grade or weight, printable on both sides on a desktop printed or other printing device. The adhesive layer may be of an adhesive of virtually any type, including acrylic, hot metal, removable or permanent. The second substrate layer may have the releasable side treated with silicone and the opposite being such that it can be printed on by a desktop printer or other printing device.

The present invention may also be in the form of a sign including a release liner which is suitable for printing thereon that is attached to an adhesive layer allowing the liner and adhesive layer to be run through a printer simultaneously. Or, it may be in the form of a sign including front and back release liners which are suitable for printing thereon that are attached to the front and back faces of an adhesive layer respectively allowing the liners and adhesive layer to be run through a printer simultaneously so that printed text can be placed on either side of said sign. A portion of the perimeter of one of the release liners may be removed to expose the adhesive layer which can then be used to attach the sign to a surface by pressing the adhesive onto that surface

### BRIEF DESCRIPTION OF THE DRAWINGS

FIG. 1 is a perspective view of a sign embodying features of the present invention;

FIG. 2 is a perspective view of the sign of FIG. 1 showing removal of a portion of substrate and exposure of adhesive;

FIG. 3 is an elevational view of a sign embodying features of the present invention being posted to the inside of a transparent surface; and

FIG. 4 is an elevational view of the sign FIG. 3 being posted to the outside of the transparent surface.

### DETAILED DESCRIPTION OF THE PREFERRED EMBODIMENT

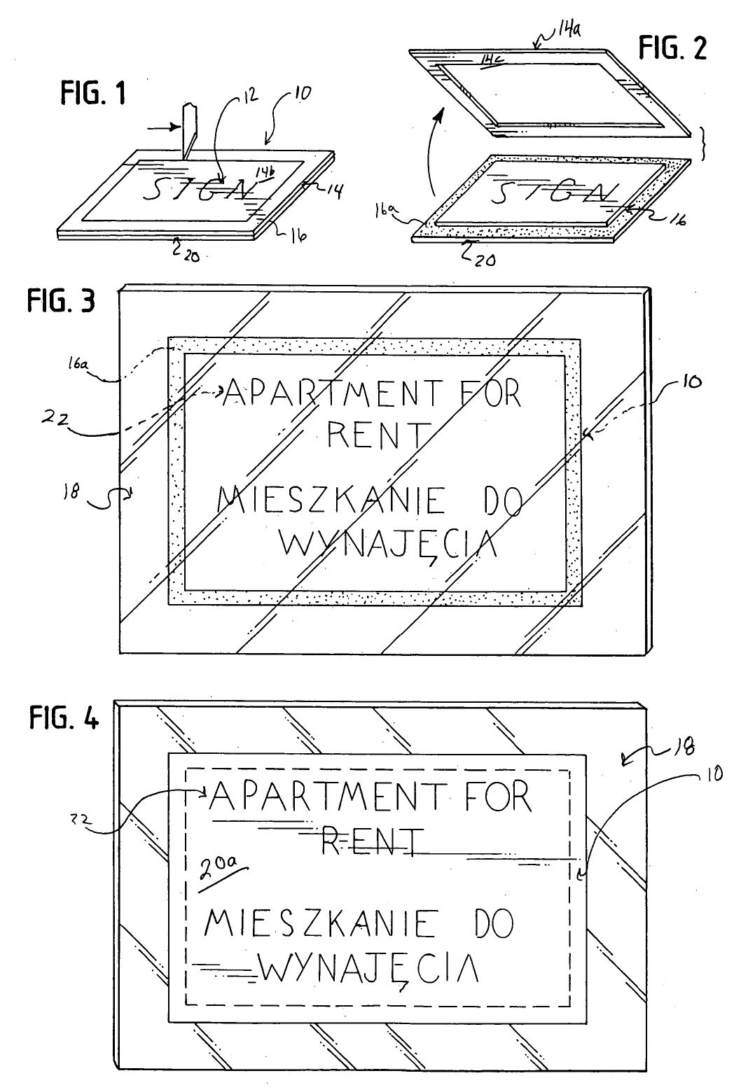

In FIGS. 1-4, the present invention is illustrated in the form of a pressure-sensitive self-posting sign 10 that includes printed material 12 that can be added using a printer, such as a desktop printer, or other printing device. The sign 10 is printable on both sides in various colors and languages. To post the sign 10 to be viewed through a transparent surface, such as a window, a portion 14a of a top side pressure sensitive liner material 14 about the printed material would be removed to expose a portion 16a of an adhesive layer 16 about the perimeter. The exposed adhesive 16a is then used to post the sign 10 to the interior of a transparent surface 18, such as glass. The other side of sign may also be printed on (FIG. 4) so that the sign 10 can convey information from both sides, such as through the window to the outside and on the inside. Alternatively, it can convey information only on the inside, such as when it is posted to an opaque surface.

More specifically, the first layer 14 of the sign 10 includes one side 14b that can be printed on and an opposite side 14c treated, such as with silicon or other known substance, so as to be releasable from the pressure sensitive adhesive layer 16. The sign also includes a third layer 20 with one side being coated with the pressure sensitive adhesive layer 16 and an opposite printable side 20a.

The perimeter 14a of the pressure sensitive silicone-treated liner 10 could be predie-cut for easy removal or cut as necessary to expose the adhesive 16 to post the sign 10 on the inside of the transparent surface 18. Alternative, the entire first layer 14 could be removed to post the sign on an opaque surface, or the inside of a glass surface.

Virtually any printable stock, whether it be paper, plastic, vinyl, tag, etc., can be used, from 12-pound paper, to 18-point board, and up, as can virtually any sort of adhesive, including hot melt, acrylic, removable and permanent varieties. The sign 10 can be cut into virtually any shape, from a simple geometric shape to a cloud shape, animal shape, vehicle shape, fruit and vegetable shape, etc.

The sign 10 can be of any size that can be accommodated by a printing device. Any printed text or image, such as printed-text 12 or 22, can be printed from using a personal computer and printer, thereby providing thousands of combinations of messages, languages, styles, colors and images. For example, a user could select his or her choice of sign message, for example: No Smoking, No Trespassing, For Rent, For Sale, 50% Off, etc., choose a language or multiple languages and print the sign. The user also has the option of entering text or images for a custom sign in as many configurations as the printing device will permit.

The sign 10 is completely self-contained, eliminating the need for any secondary applicator, such as adhesive, tape, Velcro, suction cup, etc. The first layer can be virtually any variety of printable stock, including but not limited to: paper, board, vinyl, plastic or tag. The sign 10 can be produced using virtually any sort of adhesive, including but not limited to: hot melt, acrylic, removable and permanent varieties. The sign 10 can be printed on either or both sides and can be affixed on the interior or exterior of transparent or opaque surfaces without any structural variation.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

It is claimed:

1. A sign comprising:
a first substrate layer having a printable side and an opposite side;
an adhesive layer attached to the opposite of the first substrate layer;
a second substrate layer having an adhesive releasable side attached to the adhesive layer and an opposite printable side;
at least a portion of the second layer being removable to expose the adhesive layer; and
indicia on at least one of the printable sides of the first and second substrate layers.

2. A sign in accordance with claim 1 wherein the first substrate layer is of printable stock of virtually any type, grade or weight, printable on both sides on a desktop printed or other printing device.

3. A sign in accordance with claim 2 wherein the adhesive layer is of an adhesive of virtually any type, including acrylic, hot metal, removable or permanent.

4. A sign in accordance with claim 3 wherein the second substrate layer has the releasable side treated with silicone and the opposite printable side such that it can be printed on by a desktop printer or other printing device.

5. A sign comprising a release liner which is suitable for printing thereon that is attached to an adhesive layer allowing the liner and adhesive layer to be run through a printer simultaneously.

6. A sign comprising front and back release liners which are suitable for printing thereon that are attached to the front and back faces of an adhesive layer respectively allowing the liners and adhesive layer to be run through a printer simultaneously so that printed text can be placed on either side of said sign.

7. A sign in accordance with claim 6 wherein a portion of the perimeter of one of said release liners has been removed exposing the adhesive layer which can then be used to attach the sign to a surface by pressing the adhesive onto that surface.
